(19) United States
(12) Patent Application Publication
(10) Pub. No.: US 2014/0236324 A1
(43) Pub. Date: Aug. 21, 2014

(54) APPARATUS AND METHOD FOR CONTROLLING TERMINAL BASED ON LIVING PATTERN

(71) Applicant: Electronics and Telecommunications Research Institute, Daejeon (KR)

(72) Inventors: Eun Jin KO, Daejeon (KR); Mi Kyong HAN, Daejeon (KR); Jong Hyun JANG, Daejeon (KR); Kwang Roh PARK, Daejeon (KR)

(73) Assignee: Electronics and Telecommunications Research Institute, Daejeon (KR)

(21) Appl. No.: 14/099,850

(22) Filed: Dec. 6, 2013

(30) Foreign Application Priority Data
Feb. 20, 2013 (KR) 10-2013-0017962

(51) Int. Cl. G05B 15/02

(52) U.S. Cl. CPC G05B 15/02
USPC 700/90

(57) ABSTRACT

Provided is an apparatus and method for controlling a terminal based on a living pattern, the apparatus including an interface configured to read n sets of physical terminal use information from a database, and select, from among the read n sets of physical terminal use information, m sets of physical terminal use information of which a difference in length between a set reference time and a start time or a termination time is less than or equal to a length of set interval time, each of n and m denoting a natural number, and a processor configured to generate a virtual terminal profile based on the m sets of physical terminal use information and control a virtual terminal included in the generated virtual terminal profile.

### CROSS-REFERENCE TO RELATED APPLICATION

This application claims the priority benefit of Korean Patent Application No. 10-2013-0017962, filed on Feb. 20, 2013, in the Korean Intellectual Property Office, the disclosure of which is incorporated herein by reference.

### BACKGROUND

1. Field of the Invention

The present invention relates to a technology for controlling a terminal located in a residence based on a living pattern.

2. Description of the Related Art

Recently, since electric home appliances in which a smart device or a smart interface is mounted are readily available and the electric home appliances are connected to an existing home network for operation, use of electric home appliances has become increasingly convenient in residential life.

However, due to complex functions of electric home appliances intended to provide convenience, use of control equipment, for example, a remote control or a control interface associated with the home electric appliances, is correspondingly becoming more complicated. Also, when a plurality of electric home appliances is operated, separate control of each appliance is necessary and thus, may cause an inconvenience for users.

Accordingly, there is a desire for a technology for controlling electric home appliances with ease and convenience.

### SUMMARY

An aspect of the present invention provides an apparatus and method for generating a virtual terminal profile based on physical terminal use information, controlling a virtual terminal included in the virtual terminal profile or a plurality of physical terminals related to the virtual terminal, and thereby integrally controlling the plurality of physical terminals with ease and convenience based on a living pattern.

Another aspect of the present invention also provides an apparatus and method for operating a plurality of physical terminals related to a virtual terminal based on an identified use menu for each of the plurality of physical terminals, and thereby controlling the plurality of physical terminals and the use menu for each of the plurality of physical terminals.

According to an aspect of the present invention, there is provided an apparatus for controlling a terminal based on a living pattern, the apparatus including an interface configured to read n sets of physical terminal use information from a database, and select, from among the read n sets of physical terminal use information, m sets of physical terminal use information of which a difference in length between a set reference time and a start time or a termination time is less than or equal to a length of set interval time, each of n and m denoting a natural number, and a processor configured to generate a virtual terminal profile based on the m sets of physical terminal use information and control a virtual terminal included in the generated virtual terminal profile.

According to another aspect of the present invention, there is also provided a method of controlling a terminal based on a living pattern, the method including reading n sets of physical terminal use information from a database and selecting, from among the read n sets of physical terminal use information, m sets of physical terminal use information of which a difference in length between a set reference time and a start time or a termination time is less than or equal to a length of set interval time, each of n and m denoting a natural number, generating a virtual terminal profile based on the m sets of physical terminal use information, and controlling a virtual terminal included in the generated virtual terminal profile.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an example of a configuration of a system for controlling a terminal based on a living pattern according to an embodiment of the present invention;

FIG. 2 is a diagram illustrating an example of data for use in an apparatus for controlling a terminal based on a living pattern according to an embodiment of the present invention;

FIG. 3 is a block diagram illustrating an example of a configuration of an apparatus for controlling a terminal based on a living pattern according to an embodiment of the present invention;

FIG. 4 is a flowchart illustrating a virtual terminal profile generation scheme in an apparatus for controlling a terminal based on a living pattern according to an embodiment of the present invention; and

FIG. 5 is a flowchart illustrating a method of controlling a terminal based on a living pattern according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

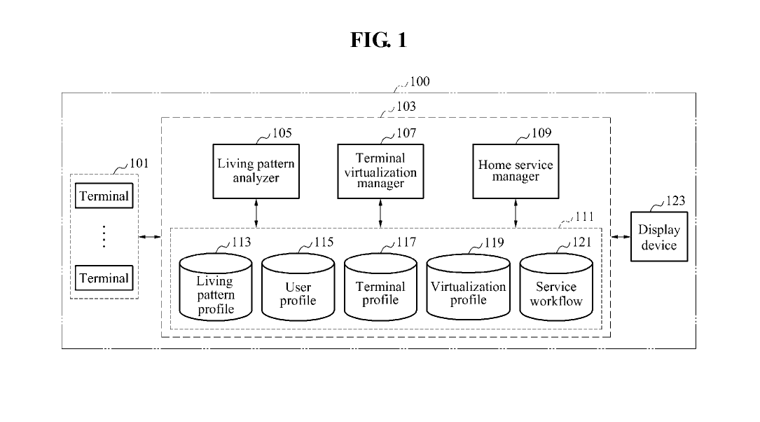

FIG. 1 is a block diagram illustrating an example of a configuration of a system 100 for controlling a terminal based on a living pattern according to an embodiment of the present invention.

Referring to FIG. 1, the system 100 for controlling a terminal based on a living pattern according to an embodiment of the present invention may include a plurality of terminals 101, an apparatus 103 for controlling a terminal based on a living pattern, and a display device 123. Hereinafter, the apparatus 103 for controlling a terminal based on a living pattern is referred to as a terminal control apparatus 103.

The plurality of terminals 101 may refer to a physical terminal located in a residence. For example, the plurality of terminals 101 may include a microwave oven, an electric rice cooker, a robot cleaner, an electric heating appliance, and the like.

Operations, for example, turning power on and off, menu selection, and the like, of the plurality of terminals 101, may be controlled by the terminal control apparatus 103.

The terminal control apparatus 103 may receive physical terminal information, for example, a type of a terminal, associated with each of the plurality of terminals 101 from the plurality of terminals 101 or be input the physical terminal information by a user.

The terminal control apparatus 103 may include a living pattern analyzer 105, a terminal virtualization manager 107, a home service manager 109, and a database 111.

The living pattern analyzer 105 may analyze a living pattern based on a living pattern profile 113 obtained by analyzing a use history of the plurality of terminals 101 and a user profile 115 including user information associated with a user residing in a residence.

The terminal virtualization manager 107 may be linked with a terminal profile 117 including physical terminal information associated with the plurality of terminals 101 and a virtualization profile 119 including virtual terminal information, and thereby performing a virtualization process of a terminal.

The home service manager 109 may be liked with a service workflow 121 managing a workflow to provide a user with a service using a terminal virtualization technology in a residence, and thereby managing a home service.

The database 111 may store at least one of the living pattern profile 113, the user profile 115, the terminal profile 117, the virtualization profile 119, and the service workflow 121.

The terminal control apparatus 103 may be linked with the plurality of terminals 101 and collect a use history of a terminal. Based on a living pattern profile obtained by analyzing the collected use history, the terminal control apparatus 103 may generate virtual terminal information, and then control the plurality of terminals 101 based on the generated virtual terminal information. Thus, the terminal control apparatus 103 may provide a user with convenience for controlling a terminal.

Also, the terminal control apparatus 103 may provide the virtual terminal information to the display device 123. In this instance, when a control command based on the virtual terminal information is received from the display device 123, the terminal control apparatus 103 may control the plurality of terminals 101 according to the control command, thereby enabling a user to easily and quickly use a virtualization-based terminal.

The display device 123 may be, for example, a wall-pad or a mobile smart device. The display device 123 may receive the virtual terminal information from the terminal control apparatus 103 to display the virtual terminal information, or transmit a control command based on a user control to the terminal control apparatus 103.

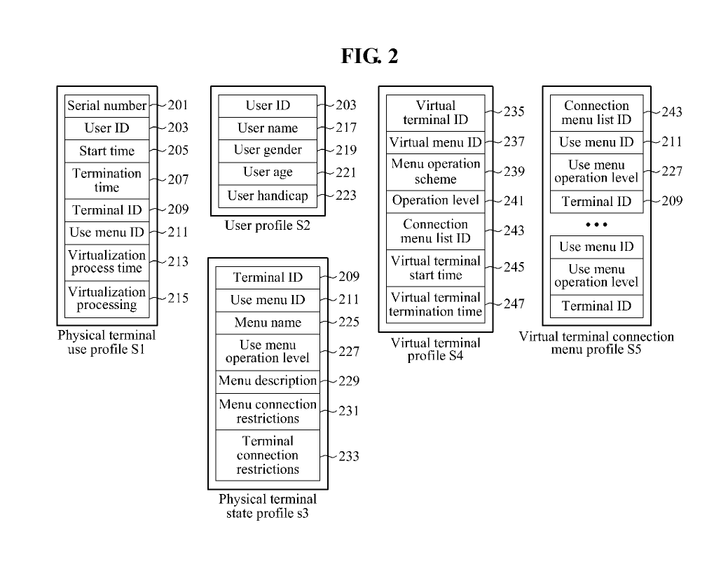

FIG. 2 is a diagram illustrating an example of data for use in an apparatus for controlling a terminal based on a living pattern according to an embodiment of the present invention.

Referring to FIG. 2, the apparatus for controlling a terminal based on a living pattern may control a terminal using data associated with a physical terminal and a user, and data associated with a virtual terminal.

The apparatus for controlling a terminal based on a living pattern may use, for example, a physical terminal use profile S1, a user profile S2, and a physical terminal state profile S3 as the data associated with a physical terminal and a user.

The physical terminal use profile S1 may include, for example, a serial number 201, a user identification (ID) 203 for identifying a user, a start time 205 in which an average start time of a terminal is recorded, a termination time 207 in which an average termination time is recorded, a terminal ID 209 used for identification, a use menu ID 211 in which a specific use menu of a terminal is recorded, a virtualization process time 213 in which a predetermined time is recorded when a history of a terminal being used as a virtual terminal at the predetermined time is present, and virtualization processing 215 indicating whether a history of a terminal being used as a virtual terminal is present.

The user profile S2 may include the user ID 203, a user name 217, a user gender 219, a user age 221, and a user handicap 223 in which terminal use constraints that may exist for a user is recorded.

The physical terminal state profile S3 may include the terminal ID 209 for identifying a physical terminal, the use menu ID 211 for identifying a use menu, a menu name 225, a use menu operation level 227 for indicating a level of a use menu, a menu description 229 indicating descriptive information associated with a menu function, menu connection restrictions 231 for restricting a virtualization connection of a menu for a case in which a physical terminal is used as a virtual terminal, and terminal connection restrictions 233 for restricting use of a physical terminal as a virtual terminal.

In addition, the apparatus for controlling a terminal based on a living pattern may use a virtual terminal profile S4 and a virtual terminal connection menu profile S5 as the data associated with a virtual terminal.

The virtual terminal profile S4 may include a virtual terminal ID 235 for identifying a virtual terminal, a virtual menu ID 237 for identifying a virtual menu, a menu operation scheme 239 in which a scheme for a menu operation is recorded, an operation level 241 in which operation level information of a corresponding menu of a virtual terminal is included, a connection menu list ID 243 for identifying a connection menu group connected with a virtual terminal or a virtual menu, a virtual terminal start time 245 indicating a start time of a virtual terminal based on a living pattern, and a virtual terminal termination time 247 indicating a termination time of a virtual terminal based on a living pattern.

The virtual terminal connection menu profile S5 may include the connection menu list ID 243, the use menu ID 211, the use menu operation level 227, and the terminal ID 209.

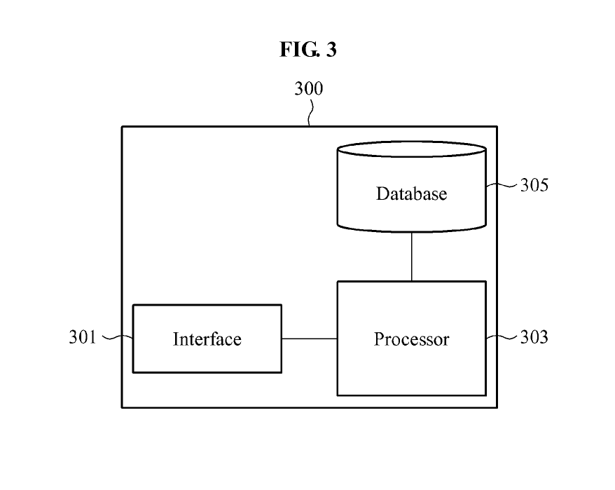

FIG. 3 is a block diagram illustrating an example of a configuration of an apparatus 300 for controlling a terminal based on a living pattern according to an embodiment of the present invention.

Referring to FIG. 3, the apparatus 300 for controlling a terminal based on a living pattern may include an interface 301, a processor 303, and a database 305.

The interface 301 may read n sets of physical terminal use information from the database 305. Here, n denotes a natural number and physical terminal use information may include, for example, a physical terminal ID, a use menu ID, menu connection restrictions, terminal connection restrictions, and the like.

In this instance, when a physical terminal virtualization function is initiated, the interface 301 may obtain a physical terminal use profile indicating a living pattern from the database 305, and read n sets of physical terminal use information in which “NO” is recoded in response to an inquiry regarding whether virtualization is processed, from the obtained physical terminal use profile.

From among the read n sets of physical terminal use information, the interface 301 may select m sets of physical terminal use information of which a difference in length between a start time and a set reference time, for example, a current time is less than or equal to a set interval time, for example, 10 minutes, or a difference in length between a termination time and a set reference time, for example, a current time is less than or equal to a set interval time, for example, 10 minutes. Here, m denotes a natural number.

From among the selected m sets of physical terminal use information, the interface 301 may extract p sets of physical terminal use information for use in virtualization, aside from the physical terminal use information including menu connection restrictions or terminal connection restrictions. Here, p denotes a natural number.

In this instance, the interface 301 may change the recorded “NO” to “YES” as a response as to whether virtualization is processed, in the extracted physical terminal use information.

The processor 303 may generate, by the interface 301, a virtual terminal profile based on the m sets of physical terminal use information or the extracted p sets of physical terminal use information, and control a virtual terminal included in the generated virtual terminal profile.

The processor 303 may calculate an average start time by averaging start times included in the m or p sets of physical terminal use information and calculate an average termination time by averaging termination times included in the m or p sets of physical terminal use information.

The processor 303 may generate the virtual terminal profile using the m or p sets of physical terminal use information, the average start time, and the average termination time, and store the generated virtual terminal profile in the database 305. Here, the processor 303 may generate the virtual terminal profile of which a virtual terminal start time and a virtual terminal termination time adopt the calculated average start time and the calculated average termination time, respectively.

The processor 303 may verify whether a user is present in a residence in which a plurality of physical terminals is located. In this instance, when the user is absent in the residence the processor 303 may verify, using a sensor, whether the user is present in the residence after a period of a set interval time ends.

When the user is present in the home, the processor 303 may verify whether a first current time matches a virtual terminal start time included in the virtual terminal profile.

When the first current time does not match a virtual terminal start time, the processor 303 may verify whether the first current time varying based on a set period of time matches the virtual terminal start time after the set period of time ends. When the first current time matches the virtual terminal start time, the processor 303 may transmit, to a display device, a virtual terminal included in the virtual terminal profile. In this instance, when the first current time matches the virtual terminal start time, the processor 303 may control a plurality of physical terminals related to the virtual terminal to operate automatically. Alternatively, when an operation request is received from the display device, the processor 303 may control the plurality of physical terminals related to the virtual terminal to operate. Here, the processor 303 may use a connection menu list ID included in the virtual terminal profile, identify the plurality of physical terminals connected with the virtual terminal and a use menu for each of the plurality of physical terminals, and operates the plurality of physical terminals based on the use menu for each of the plurality of physical terminals.

Also, the processor 303 may verify whether a second current time matches a virtual terminal termination time. When the second current time does not match the virtual terminal termination time, the processor 303 may verify whether the second current time varying based on a set period of time matches the virtual terminal termination time after the set period of time ends. When the second current time matches the virtual terminal termination time, the processor 303 may transmit, to the display device, a query request inquiring whether the virtual terminal is to be terminated.

When the processor 303 receives a “non-termination” response from the display device in response to the query request, operations of the plurality of physical terminals associated with the virtual terminal may be maintained. When the processor 303 receives a “termination” response from the display device in response to the query request, the operations of the plurality of physical terminals related to the virtual terminal may be terminated. In this instance, in order to update the physical terminal use information, the processor 303 may use the connection menu list ID included in the virtual terminal profile, and change termination times included in a plurality of sets of physical terminal use information corresponding to the identified plurality of physical terminals, to termination times at which the operations of the plurality of physical terminals related to the virtual terminal.

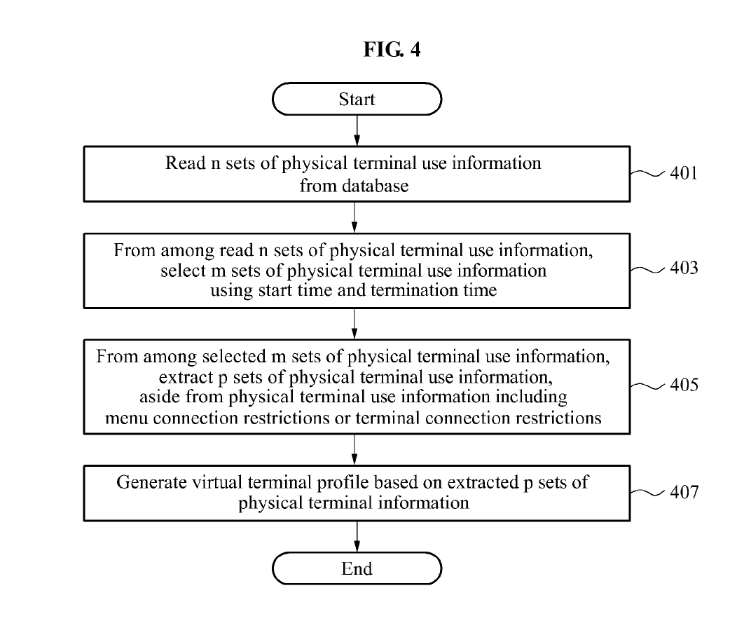

FIG. 4 is a flowchart illustrating a virtual terminal profile generation scheme in an apparatus for controlling a terminal based on a living pattern according to an embodiment of the present invention.

Referring to FIG. 4, in operation 401, the apparatus for controlling a terminal based on a living pattern may read n sets of physical terminal use information from a database. Here, n denotes a natural number and physical terminal use information may include, for example, a physical terminal ID, a use menu ID, menu connection restrictions, terminal connection restrictions, and the like.

In particular, the apparatus for controlling a terminal based on a living pattern may obtain a physical terminal use profile indicating a living pattern from the database and, from the obtained terminal use profile, read n sets of physical terminal use information in which “NO” is recorded in response to an inquiry regarding whether virtualization is processed.

In operation 403, from among the read n sets of physical terminal use information, the apparatus for controlling a terminal based on a living pattern may select m sets of physical terminal use information by using a start time and a termination time. Here, m denotes a natural number. For example, the apparatus for controlling a terminal based on a living pattern may select, from among the read n sets of physical terminal use information, the m sets of physical terminal use information of which a difference in length between the start time and a set reference time, for example, a current time, is less than or equal to a length of a set interval time, for example, 10 minutes or a difference in length between the termination time and a set reference time, for example, a current time is less than or equal to a length of a set interval time, for example, 10 minutes.

In operation 405, the apparatus for controlling a terminal based on a living pattern may extract, from among the selected m sets of physical terminal use information, p sets of physical terminal use information for use in virtualization, aside from physical terminal use information including menu connection restrictions or terminal connection restrictions. Here, p denotes a natural number.

In operation 407, the apparatus for controlling a terminal based on a living pattern may generate a virtual terminal profile based on the extracted p sets of physical terminal information. Here, the virtual terminal profile may include, for example, a virtual terminal ID, a virtual menu ID, an operation level, a connection menu list ID, a virtual terminal start time, a virtual terminal termination time, and the like.

In this instance, the apparatus for controlling a terminal based on a living pattern may calculate an average start time by averaging start times included in the p sets of physical terminal use information and calculate an average termination time by averaging termination times included in the p sets of physical terminal use information. The apparatus for controlling a terminal based on a living pattern may use the p sets of physical terminal use information, the average start time, and the average termination time, generate the virtual terminal profile, and store the generated virtual terminal profile in a database. In this instance, the apparatus for controlling a terminal based on a living pattern may generate the virtual terminal profile of which the virtual terminal start time and the virtual terminal termination time adopt the calculated average start time and the calculated average termination time, respectively.

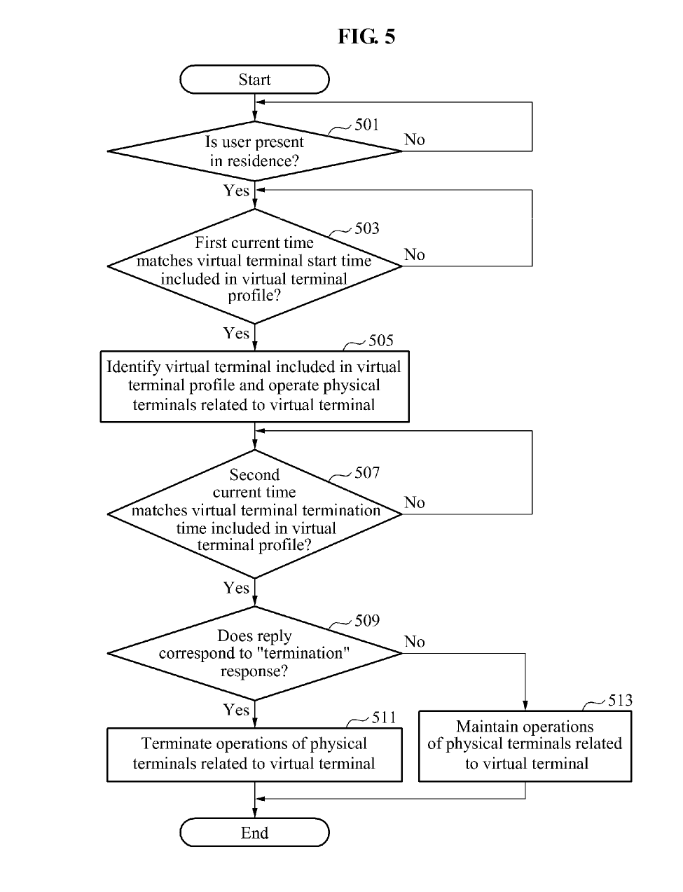

FIG. 5 is a flowchart illustrating a method of controlling a terminal based on a living pattern according to an embodiment of the present invention.

Referring to FIG. 5, in operation 501, the apparatus for controlling a terminal based on a living pattern may verify whether a user is present in a residence in which a plurality of physical terminals is located.

When the user is absent in the residence, the apparatus for controlling a terminal based on a living pattern may move to the operation 501 and verify whether the user is present in the residence after a set period of time ends.

In operation 503, when the user is present in the residence, the apparatus for controlling a terminal based on a living pattern may verify whether a first current time matches a virtual terminal start time included in a virtual terminal profile.

When the first current time does not match the virtual terminal start time, the apparatus for controlling a terminal based on a living pattern may move to operation 503 and verify whether the first current time varying based on a set period of time matches the virtual terminal start time after the set period of time ends.

In operation 505, when the first current time matches the virtual terminal start time, the apparatus for controlling a terminal based on a living pattern may identify a virtual terminal included in the virtual terminal profile and operate a plurality of physical terminals related to the virtual terminal.

In this instance, the apparatus for controlling a terminal based on a living pattern may control the plurality of physical terminals related to the virtual terminal to operate automatically. Alternatively, the apparatus for controlling a terminal based on a living pattern may transmit the virtual terminal to a display device and control the plurality of physical terminals related to the virtual terminal to operate when an operation request is received from the display device. Here, the apparatus for controlling a terminal based on a living pattern may use a connection menu list ID included in the virtual terminal profile, identify the plurality of physical terminals connected with the virtual terminal and a use menu for each of the plurality of physical terminals, and operate the plurality of physical terminals based on the use menu for each of the plurality of physical terminals.

In operation 507, the apparatus for controlling a terminal based on a living pattern may verify whether a second current time matches a virtual terminal termination time included in the virtual terminal profile.

When the second current time does not match the virtual terminal termination time, the apparatus for controlling a terminal based on a living pattern may move to the operation 507 and verify whether a second current time varying based on a set period of time matches to the virtual terminal termination time after the set period of time ends.

In operation 509, when the second current time matches the virtual terminal termination time, the apparatus for controlling a terminal based on a living pattern may transmit, to the display device, a query request inquiring whether the virtual terminal is to be terminated, receive a response in response to the query request, and verify whether the virtual terminal is terminated.

In operation 511, when a “termination” response is received from the display device in response to the query request, the apparatus for controlling a terminal based on a living pattern may terminate operations of the plurality of physical terminals related to the virtual terminal. In this instance, in order to update physical terminal use information, the apparatus for controlling a terminal based on a living pattern may use a connection menu list ID included in the virtual terminal profile, and change termination times included in a plurality of sets of physical terminal use information corresponding to the identified plurality of physical terminals, to termination times at which the operations of the plurality of physical terminals related to the virtual terminal.

In operation 513, when a “non-termination” response is received from the display device in response to the query response, the apparatus for controlling a terminal based on a living pattern may maintain the operations of the plurality of physical terminals related to the virtual terminal.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

According to an embodiment of the present invention, it is possible to integrally control a plurality of physical terminals with ease and convenience based on a living pattern by generating a virtual terminal profile based on physical terminal use information and controlling a virtual terminal included in the virtual terminal profile or the plurality of physical terminals related to the virtual terminal.

According to another embodiment of the present invention, it is also possible to control a plurality of physical terminals and a use menu for each of the plurality of physical terminals by operation the plurality of physical terminals related to a virtual terminals based on an identified use menu for each of the plurality of physical terminals.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling a terminal based on a living pattern, the apparatus comprising:
an interface configured to read n sets of physical terminal use information from a database, and select, from among the read n sets of physical terminal use information, m sets of physical terminal use information of which a difference in length between a set reference time and a start time or a termination time is less than or equal to a length of a set interval time, each of n and m denoting a natural number; and
a processor configured to generate a virtual terminal profile based on the m sets of physical terminal use information and control a virtual terminal included in the generated virtual terminal profile.

2. The apparatus of claim 1, wherein the processor is configured to
calculate an average start time by averaging start times included in the m sets of physical terminal use information, and calculate an average termination time by averaging termination times included in the m sets of physical terminal use information, and
generate the virtual terminal profile of which a virtual terminal start time and a virtual terminal termination time adopt the calculated average start time and the calculated average termination time, respectively.

3. The apparatus of claim 1, wherein the interface is configured to extract p sets of physical terminal use information, aside from physical terminal use information including menu connection restrictions or terminal connection restrictions, from among m sets of physical terminal use information, p denoting a natural number,
wherein the processor is configured to generate the virtual terminal profile based on the extracted p sets of physical terminal use information.

4. The apparatus of claim 1, wherein, when a user is present in a residence, the processor is configured to verify whether a first current time matches a virtual terminal start time included in the virtual terminal profile and, when the first current time matches the virtual terminal start time, operate a plurality of physical terminals related to the virtual terminal.

5. The apparatus of claim 4, wherein the processor is configured to use a connection menu list identification (ID) included in the virtual terminal profile, identify a plurality of physical terminals connected to the virtual terminal and a use menu for each of the plurality of physical terminals, and operate the plurality of physical terminals based on the use menu for each of the plurality of physical terminals.

6. The apparatus of claim 4, wherein the processor is configured to
verify whether a second current time matches a virtual terminal termination time included in the virtual terminal profile and, when the second current time matches the virtual termination time, transmit, to a display device, a query request inquiring whether the virtual terminal is to be terminated, and
maintain operations of the plurality of physical terminals related to the virtual terminal when a “non-termination” response is received from the display device.

7. The apparatus of claim 4, wherein the processor is configured to
verify whether a second current time matches a virtual terminal termination time included in the virtual terminal profile and, when the second current matches the virtual termination time, transmit, to a display device, a query request inquiring whether the virtual terminal is to be terminated,
terminate operations of the plurality of physical terminals related to the virtual terminal when a “termination” response is received from the display device, and
change termination times included in a plurality sets of physical terminal use information corresponding to the plurality of physical terminals, to termination times at which the operations of the plurality of physical terminals are terminated.

8. A method of controlling a terminal based on a living pattern, the method comprising:
reading n sets of physical terminal use information from a database, and selecting, from among the read n sets of physical terminal use information, m sets of physical terminal use information of which a difference in length between a set reference time and a start time or a termination time is less than or equal to a length of set interval time, each of n and m denoting a natural number; and
generating a virtual terminal profile based on the m sets of physical terminal use information, and
controlling a virtual terminal included in the generated virtual terminal profile.

9. The method of claim 8, wherein the generating comprises:
calculating an average start time by averaging start times included in the m sets of physical terminal use information, and calculating an average termination time by averaging termination times included in the m sets of physical terminal use information; and
generating the virtual terminal profile of which a virtual terminal start time and a virtual terminal termination time adopt the calculated average start time and the calculated average termination time, respectively.

10. The method of claim 8, further comprising:
extracting p sets of physical terminal use information aside from physical terminal use information including menu connection restrictions or terminal connection restrictions, from among m sets of physical terminal use information, p denoting a natural number,
wherein the generating comprises generating the virtual terminal profile based on the extracted p sets of physical terminal use information.

11. The method of claim 8, wherein the controlling comprises, when a user is present in a residence, verifying whether a first current time matches a virtual terminal start time included in the virtual terminal profile and operating a plurality of physical terminals related to the virtual terminal when the first current time matches the virtual terminal start time.

12. The method of claim 11, wherein the operating comprises using a connection menu list identification (ID) included in the virtual terminal profile, identifying a plurality of physical terminals connected to the virtual terminal and a use menu for each of the a plurality of physical terminals, and operating the plurality of physical terminals based on the use menu for each of the plurality of physical terminals.

13. The method of claim 11, wherein the operating comprises:
verifying whether a second current time matches a virtual terminal termination time included in the virtual terminal profile and transmitting, to a display device, a query request inquiring whether the virtual terminal is to be terminated when the second current time matches the virtual termination time; and
maintaining operations of the plurality of physical terminals related to the virtual terminal when a “non-termination” response is received from the display device.

14. The method of claim 11, wherein the operating comprises:
verifying whether a second current time matches a virtual terminal termination time included in the virtual terminal profile and transmitting, to a display device, a query request inquiring whether the virtual terminal is to be terminated when the second current time matches the virtual termination time;
terminating operations of the plurality of physical terminals related to the virtual terminal when a “termination” response is received from the display device; and
changing termination times included in a plurality of sets of physical terminal use information corresponding to the plurality of physical terminals, to termination times at which the operations of the plurality of physical terminals are terminated.
